(19) United States
(12) Patent Application Publication
(10) Pub. No.: US 2019/0349356 A1
(43) Pub. Date: Nov. 14, 2019

(54) CYBERSECURITY INTELLIGENCE PLATFORM THAT PREDICTS IMPENDING CYBER THREATS AND PROACTIVELY PROTECTS HETEROGENEOUS DEVICES USING HIGHLY-SCALABLE BIDIRECTIONAL SECURE CONNECTIONS IN A FEDERATED THREAT INTELLIGENCE ENVIRONMENT

(71) Applicant: CyberSight, Inc., Carlsbad, CA (US)

(72) Inventors: Timothy McElwee, Escondido, CA (US); Antonio Challita, Carlsbad, CA (US); Gang Ding, San Diego, CA (US)

(21) Appl. No.: 16/409,598

(22) Filed: May 10, 2019

Related U.S. Application Data
(60) Provisional application No. 62/670,603, filed on May 11, 2018.

(51) Int. Cl. H04L 29/06; H04L 29/08; G06F 21/60; G06N 20/00

(52) U.S. Cl. CPC H04L 63/0815; H04L 63/1441; G06N 20/00; H04L 67/1097; G06F 21/602; H04L 63/0876

(57) ABSTRACT

A method implemented at a cybersecurity intelligence platform for responding to a cyber-attack is disclosed. The method comprises: detecting an attack at a client device; receiving raw data from the attacked client device, the raw data comprising device data and attack-related data; performing fingerprinting analysis and attacker analysis based on the raw data to generate fingerprinting data and attacker data; issuing an incidence response to the attacked client device; and issuing a federated response to a plurality of client devices belonging to a class based on the fingerprinting data and the attacker data. The client device and a cloud component of the cybersecurity intelligence platform communicate with each other through a bi-directional secure connection that is established as needed. The cybersecurity intelligence platform coordinates responses to cyber-attacks against a plurality of client devices of heterogeneous types.

### CROSS-REFERENCE TO RELATED APPLICATIONS

This application claims the benefit of U.S. Provisional Application No. 62/670,603 filed on May 11, 2018, the disclosure of which is incorporated herein by reference.

### FIELD

The embodiments of the disclosure are directed to computer networks, and more particularly, to a platform for protecting a computer network environment.

### RELEVANT BACKGROUND

A comprehensive security solution in light of the heterogeneous network environments, proliferation of Internet of Things (IoT) devices, and increasingly sophisticated attacks is needed.

### SUMMARY

Aspects may relate to a method implemented at a cybersecurity intelligence platform for responding to a cyber-attack, the method comprising: detecting an attack at a client device; receiving raw data from the attacked client device, the raw data comprising device data and attack-related data; performing fingerprinting analysis and attacker analysis based on the raw data to generate fingerprinting data and attacker data; issuing an incidence response to the attacked client device; and issuing a federated response to a plurality of client devices belonging to a class based on the fingerprinting data and the attacker data.

### BRIEF DESCRIPTION OF THE DRAWINGS

FIG. 1 is a block diagram illustrating an example environment according to one embodiment of the disclosure.

FIG. 2 is a block diagram illustrating an environment comprising an example cloud component according to another embodiment of the disclosure.

FIG. 3 is a flowchart illustrating an example method for establishing a secure communication session initiated from outside the cloud component of the CIP.

FIG. 4 is a flowchart illustrating an example method for establishing a security communication session initiated from inside the cloud component of the CIP.

FIG. 5 is a flowchart illustrating an example method for issuing an incidence response, according to one embodiment of the disclosure.

FIG. 6 is a flowchart illustrating an example method for issuing a federated response, according to one embodiment of the disclosure.

FIG. 7 is a flowchart illustrating an example method for operating a threat intelligence platform, according to one embodiment of the disclosure.

FIG. 8 is a block diagram illustrating an example computing device, according to embodiments of the disclosure.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments. Embodiments of disclosure described herein may relate to functionality implemented across multiple devices. Obvious communications (e.g., transmissions and receipts of information) between the devices may have been omitted from the description in order not to obscure the disclosure.

In different embodiment of the disclosure, scalable secure connections, to and from, heterogeneous types of devices, as needed and when needed, are utilized. The secure connections originate in an elastic manner (as needed and when needed) from a cloud computing environment, with the ability to add cloud computing resources on demand, to establish and maintain the connections, in a manner that is scalable to a large number of devices and device types.

Embodiments of the disclosure may be utilized with heterogeneous types of devices, which may include, but are not limited to, Internet of Things (IoT) devices, computer devices, server equipment, mobile devices, router devices, Industrial Control Systems (ICS), Supervisory Control and Data Acquisition Systems (SCADA), connected vehicles, flying vehicles, connected airplanes, and connected space crafts, etc.

Therefore, in one embodiment, trusted connections to endpoint devices may be formed in a manner that allows collection of security related data and device related metadata in a centralized cybersecurity intelligence platform (CIP). Data collection happens in real-time (e.g., when cyberattacks occur) and/or at predefined intervals (e.g., under normal device operations in the absence of cyberattacks, or when attacks are dormant).

A fingerprinting database may be created based on the data collected in the CIP. The fingerprinting database may be highly-scalable and highly-diverse, and may comprise unique data points that identify device types, and determine the normal and abnormal behaviors for each device type (which can take place in near-real time).

In different embodiments, collected data in the fingerprinting database may include, but is not limited to: device type, device make, device model, software version, operating system type and version, internal and external IP (Internet Protocol) addresses, MAC (Media Access Control) address, device serial number, device geographic location (e.g., static location, or mobile location as it moves), username or device user, processor and memory information, other hardware information, running processes on device, network connections to/from device, files added/extracted/modified on device, and so on.

In one embodiment, the fingerprinting database works in conjunction with a client (software, firmware, dedicated hardware, etc.) embedded on the devices, to enable the CIP to identify and register devices rapidly into the fingerprinting database, based on the information collected from the device by the embedded client. In one embodiment, the client provides the following functionality: 1) Discover and identify devices; 2) Establish secure connections to a cloud component of the CIP; 3) Collect (send) information to the CIP; 4) Detect attacks locally, and through assistance from analytics in the CIP; 5) Perform responsive action, or proactive remediation; and so on. Attack-related analytics and/or machine learning may be performed locally on the device (e.g., by the embedded client), in addition to at the CIP. In addition to detecting the attack, locally performed attack-related analytics on the device may help prevent the attack from actually executing on the device. For example, the client may analyze an executable file locally, determine that the file is associated with a ransomware attack, and prevent the file from actually executing on the device, prior to receiving any response or assistance from the CIP.

In a further embodiment, an attackers database about cybersecurity bad actors may be created in the CIP. The attackers database may comprise the following information: attacker geographic location, types of attacks each attacker conducts, types of devices they each attack, attacker tools used, and so on.

In particular, the types of attacks in the attackers database may include, but are not limited to, ransomware, DDoS (Distributed Denial of Service), malware, phishing, lateral movement, spyware, eavesdropping, attacks with physical implications on ICS and SCADA, identity theft, credentials threat, social engineering, attacks on medical devices, attacks on healthcare providers, attacks on IoT devices, and so on.

Furthermore, the types of devices captured in the attackers database may comprise Internet of Things (IoT) devices, computer devices, server equipment, mobile devices, router devices, Industrial Control Systems (ICS), Supervisory Control and Data Acquisition Systems (SCADA), connected vehicles, flying vehicles, connected airplanes, and connected space crafts, etc.

By correlating and categorizing the attacker's characteristics (e.g., an apparent geographic location, etc.), with the types of attacks they conduct, on the types of devices they attack, and the tools they use, intelligence can be generated based on which proactive and preemptive protection of a large number of devices over a large geographical expanse before the launching of a wide scale attack can be achieved.

The combination of the fingerprint database and the attackers database may be referred to as a federated threat intelligence environment, the operation of which will be explained in further detail below.

For example, in one embodiment, if one instance of a Ransomware cybersecurity attack, on a certain device model, such as a self-driving luxury car in California, is detected (e.g., by an embedded agent), a client (e.g., the manufacturer of the self-driving luxury car) may immediately transmit the attack information using a secure connection to a cloud component of the CIP. In near real-time the CIP may dynamically form secure connections to all or nearly all self-driving luxury cars registered in the CIP around the world, and send remediation information to cars through the secure connection. This protects the cars before the attack reaches them.

One remediation example could be to blacklist incoming network connections originating from a certain geographical region in the world that the particular device has never communicated with historically under normal operations.

Another remediation action example could be to update the parameters used in the client's analytics algorithm, to detect the patterns of a new previously unseen threat that was caught and reported into the CIP.

In one embodiment, the remediation information can also be extended to other makers of autonomous cars, to proactively protect them, from the car hackers, which have been captured in the attackers database. The CIP may offer APIs (Application Program Interfaces) that provide information segmented by device types, for device makers to prevent attacks on their devices. The information can also be shared with security service providers to alert them about threats specific to their environments they are monitoring. For example, information on attackers who attack medical devices, and how to protect against them, would be highly relevant to a managed security services provider who secures hospitals or healthcare facilities.

It should be appreciated that the secure connections are both bidirectional and dynamic. This means that there could be one secure connection up (to the cloud component) that triggers an alert about a cyberattack, which leads to a large number of connections down (from the cloud component) that trigger the response to an attack. Therefore bidirectional load balancing to deploy secure connections, as and when needed, used for the purposes of detecting and responding to cybersecurity attacks globally, may be utilized.

In one embodiment, the proactive response (remediation) can be performed using blockchain technology. The use of blockchain for proactive response against cybersecurity attacks provides several advantages. First, it enables all devices registered in the system to verify that the remediation updates are authentic, through validating the one-way hash functions of the added block. Second, it enables propagation of remediation to spread rapidly to all or nearly all devices in the system, through the blockchain distributed ledger model. Third, by storing the remediation data on the blockchain, the need for devices and enterprise to maintain large databases of remediation data can be eliminated.

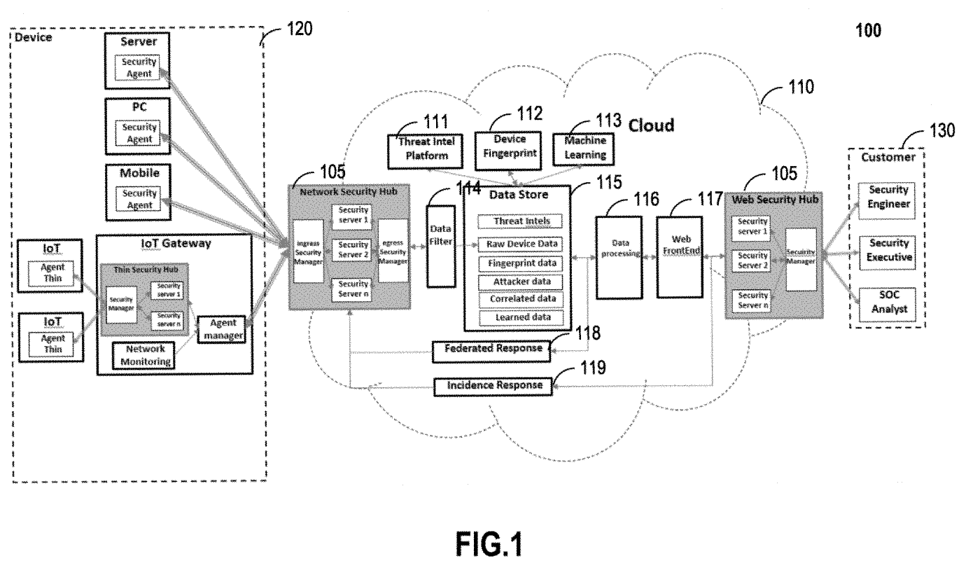

Referring to FIG. 1, a block diagram illustrating an example environment 100 according to one embodiment of the disclosure is shown. A cloud component 110 of CIP is provided to implement the majority of the functions of the CIP. Connections between the cloud component 110 and external parties are secured through (network/web) security hubs 105, where external parties may include client devices 120 and customers 130. The security hubs 105 each comprises one or more security servers and ingress/egress security servers. The operations of the security hubs 105 will be described in further detail below.

Client devices 120 may comprise such devices as servers, personal computers, mobile devices, IoT devices, etc. An embedded agent may be installed in a client device 120 to facilitate security-related data collection and transmission to the cloud component 110. In the case of IoT devices, each IoT device may be embedded with a thin agent which, in combination with a managed agent installed on an IoT gateway on the client side, facilitates the data collection and transmission. One IoT gateway may serve a plurality of client IoT devices. The connection between IoT devices and the IoT gateway may also be secured by a thin security hub, which may be similar to the security hub 105 of the cloud component 110. The IoT gateway may further implement a network monitoring module that is in communication with the managed agent to further facilitate security-related data connection for the IoT devices.

The security-related data, once collected from the client devices 120 and transmitted to the cloud component 110 by way of the network security hub 105, may be processed by a data filter 114. The processed data may be categorized and stored in the data store 115. The data store 115 may have the following categories of data stored therein: threat intelligence, raw device data, fingerprint data, attacker data, correlated data, and learned data. The threat intelligence data may be managed by a threat intelligence platform 111. The fingerprint data may be managed by a device fingerprint module 112. Further, the learned data may be managed by a machine learning module 113.

Based on the data in the data store 115, the CIP may issue incidence responses 119 to particular client devices 120 in order to respond to security incidences that have occurred at the particular client devices 120. Further, the CIP may issue a federated response 118 to a category of client devices 120 in response to security incidences that have occurred at some of the client devices 120 based on the collected data and inferences drawn from the collected data to proactively and preemptively protect the client devices 120 from attacks and/or other security incidences.

The data stored in the data store 115 may be processed by a data processing module 116 and fed into a web frontend 117. Customers 130, within the access privileges they were give, may be able to view and/or manage at least some of the data in the data store 115 through the web frontend 117. The customers 130 may comprise such personnel as security engineers, security executives, security operations center (SOC) analysts, etc. As described above, the connection between the customers 130 and the cloud component 110 of the CIP may be secured through a web security hub 105.

In one embodiment, the CIP may comprise a distributed cloud that comprises a plurality of cloud components 110. Each of the plurality of cloud components 110 may serve its respective client devices and customers. Further, the cloud components 110 may communicate with each other to exchange relevant data. The connections between the cloud components 110 may also be secured through the security hub 105.

In one embodiment, some of the client devices 120 may need to communicate with one or more associated client cloud servers through a network connection. The cloud component 110 may act as a security proxy between the client devices 120 and the client cloud servers. In other words, the connections between a client device 120 and its associated client cloud servers may pass through the cloud component 110 for added security.

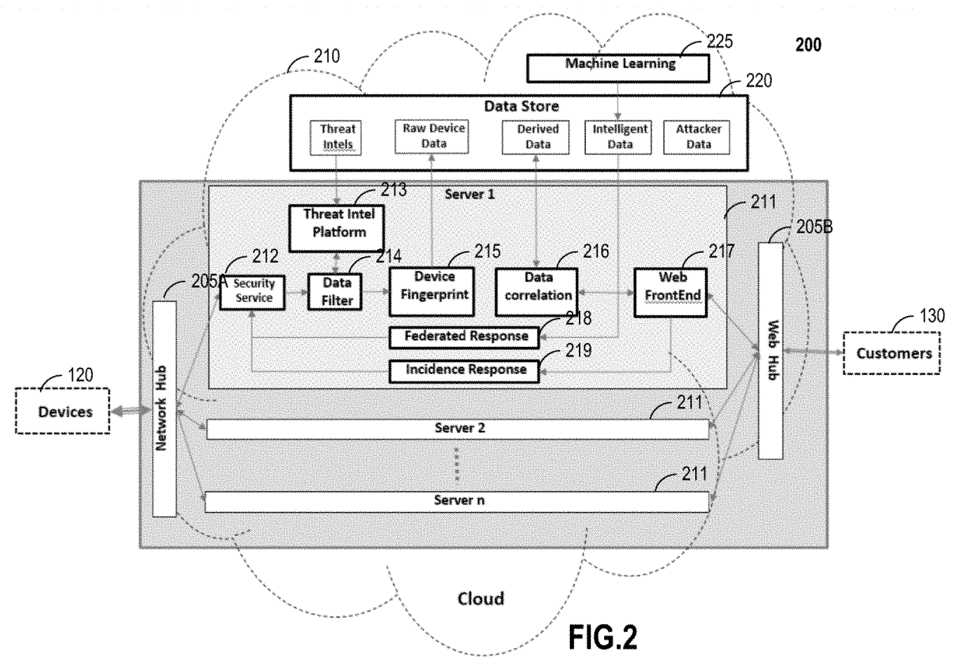

Referring to FIG. 2, a block diagram illustrating an environment 200 comprising an example cloud component according to another embodiment of the disclosure is shown. In this embodiment, the cloud component 200 may comprise a plurality of servers 211. Each of the servers 211 may perform the functionality of one of the security servers in the security hub 105 of FIG. 1 and some other functionality of the cloud component. For example, each server 211 may comprise a security service module 212, a threat intelligence platform 213, a data filter 214, a device fingerprint module 215, a data correlation module 216, and a web frontend 217, and may issue incidence responses 219 and federated responses 218 to client devices 120. The modules in FIG. 2 perform similar functionality as the modules illustrated FIG. 1.

The servers 211 may communicate with client devices through a network hub 205A of the cloud component 210, and with customer 130 through a web hub 205B of the cloud component 210. Further, a data store 220 and a machine learning module 225 may be shared by and accessible to all the servers 211. The data store 220 may have stored therein such data as threat intelligence, raw device data, derived data, intelligence data, attacker data, etc.

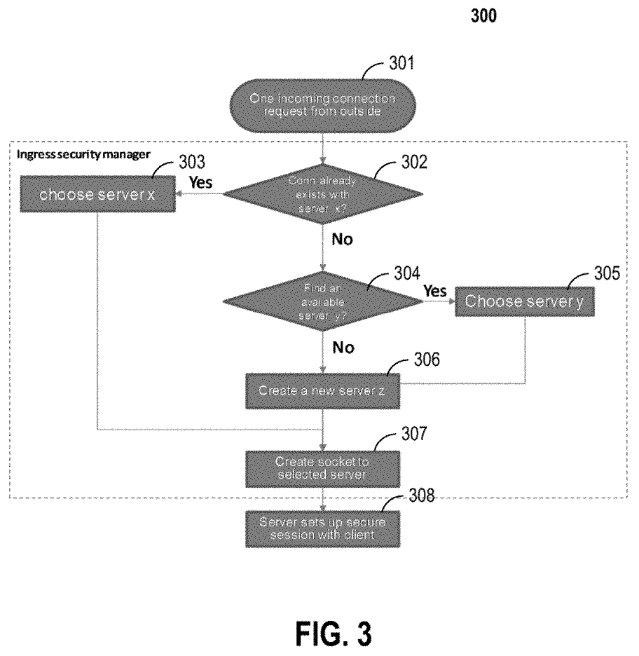

Referring to FIG. 3, a flowchart illustrating an example method 300 for establishing a secure communication session initiated from outside the cloud component of the CIP is shown. The operations of method 300 may be performed at a security hub 105 of FIG. 1. At 301, an incoming connection request from outside is received. At 302, whether a connection already exists between the outside requester/client and a first server (e.g., server X) is determined. If yes at 302, at 303, the first server (server X) is chosen. If no at 302, at 304, whether an available second server (e.g., server Y) can be found is determined. If yes at 304, at 305, the second server (server Y) is chosen. If no at 304, at, at 306, a new, third server (e.g., server Z) is created and chosen. At 307, a socket to the chosen server (e.g., server X, Y, or Z) is created. Operations at 302 through 307 may be performed at an ingress security manager. At 308, a security session with the outside requester/client is set up by the server.

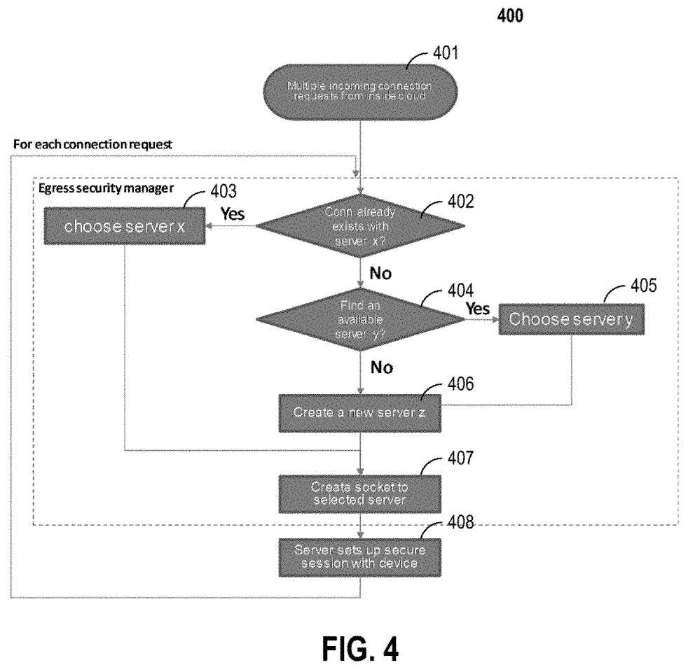

Referring to FIG. 4, a flowchart illustrating an example method 400 for establishing a security communication session initiated from inside the cloud component of the CIP is shown. The operations of method 400 may be performed at a security hub 105 of FIG. 1. At 401, multiple connection requests from inside the cloud component are received. At 402, whether a connection with the client device already exists with a first server (e.g., server X) is determined. If yes at 402, at 403, the first server (server X) is chosen. If no at 402, at 404, whether an available second server (e.g., server Y) can be found is determined. If yes at 404, at 405, the second server (server Y) is chosen. If no at 404, at 406, a new, third server (e.g., server Z) is created and chosen. At 407, a socket to the chosen server (server X, Y, or Z) is set up. Operations at 402 through 407 may be performed at an egress security manager. At 408, a secure session with the client device is set up. Operations at 402 through 408 may be performed for each connection request.

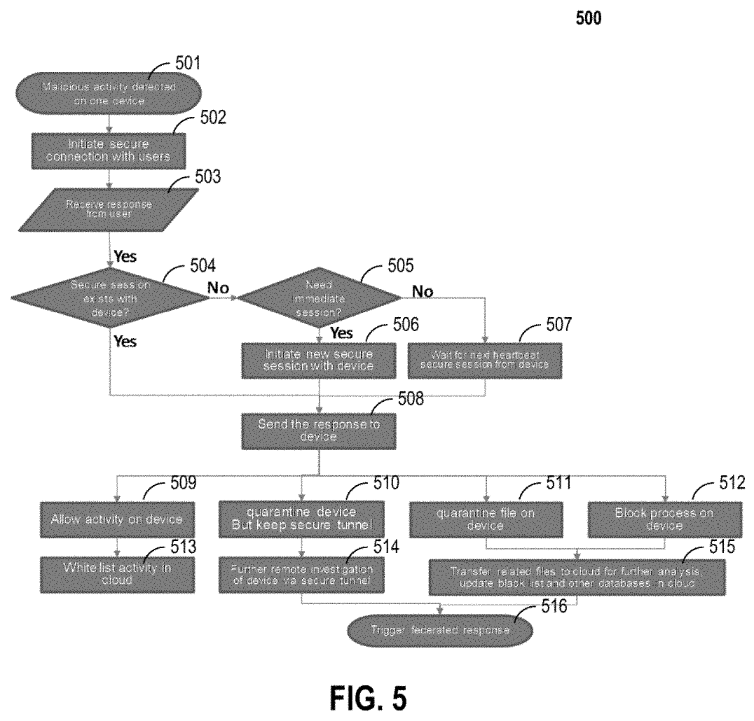

Referring to FIG. 5, a flowchart illustrating an example method 500 for issuing an incidence response, according to one embodiment of the disclosure, is shown. At 501, malicious activity (e.g., attack) is detected on one device. At 502, a secure connection with the user/client device is initiated. At 503, a response to the connection initiation request is received from the user. At 504, whether a security session already exists with the client device is determined. If yes at 504, at 508, an incidence response is sent to the client device. If no at 504, at 505, whether an immediate session is required is determined. If yes at 505, at 506, a new secure session with the client device is initiated. If no at 505, at 507, the server wait for the next heartbeat secure session from the client device. From either 506 or 507, at 508, an incidence response is sent to the client device. Based on the incidence response, at 509, the activity as allowed on the device, and at 513, the activity is whitelisted in the cloud component. Alternatively, based on the incidence response, at 510, the device is quarantined, but the secure tunnel is kept, and at 514, a further remote investigation of the device is conducted via the secure tunnel. Alternatively, based on the incidence response, at 511, a file is quarantined on the device, or at 512, a process is blocked on the device. From either 511 or 512, at 515, the related files are transferred to the cloud component for further analysis, and the blacklist and other databases in the cloud component are updated. From either 514 or 515, at 516, a federated response is triggered.

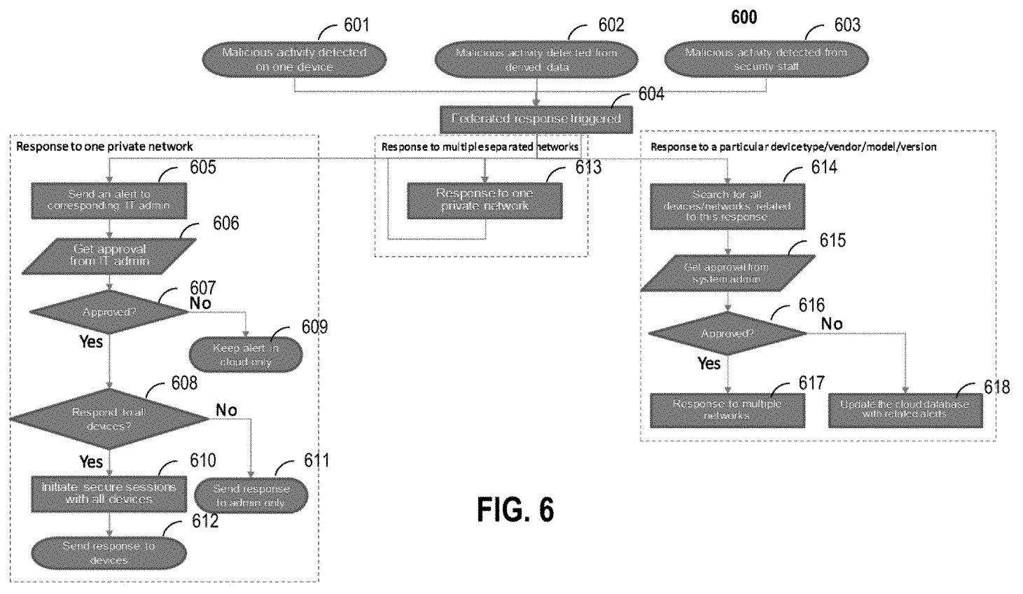

Referring to FIG. 6, a flowchart illustrating an example method 600 for issuing a federated response, according to one embodiment of the disclosure, is shown. At 601, a malicious activity is detected on one client device. At 602, a malicious activity is detected from derived data. At 603, a malicious activity is detected by security staff. From any of 601, 602, or 603, at 604, a federated response is triggered. Operations at 605 through 612 are related to a response to one private network. At 605, an alert is sent to the corresponding IT administrator. At 606, an approval from the IT administrator is requested. At 607, whether the IT administrator has approved the response is determined. If no at 607, at 609, the alert is kept in the cloud component only. If yes at 607, at 608, whether the response should be sent to all devices is determined. If no at 608, at 611, the response is sent to the administrator only. If yes at 608, at 610, secure sessions with all devices are initiated, and at 612, the response is sent to all devices. In some embodiments, actions may be taken automatically for certain alerts by default irrespective of the approval from the IT administrator. This may be especially helpful where, e.g., a large number of alerts are generated within a short time. Moreover, in some embodiments, the system behavior may be user-configurable. For example, the user (e.g., an IT administrator) may set whether actions in response to alerts can be taken automatically without approval from the IT administrator.

To respond to multiple separated networks, at 613, the operations at 605 through 612 may be repeated for each private network.

Operations at 614 through 618 related to a response to a particular device type, vendor, model, version, etc. At 614, all devices and/or network related to the response are searched for. At 615, an approval from the system administrator is requested. At 616, whether the system administrator has approved the response is determined. If no at 616, at 618, the cloud database is updated with related alerts, and the response is not sent to outside devices or networks. If yes at 616, at 617, the response is issued to multiple networks.

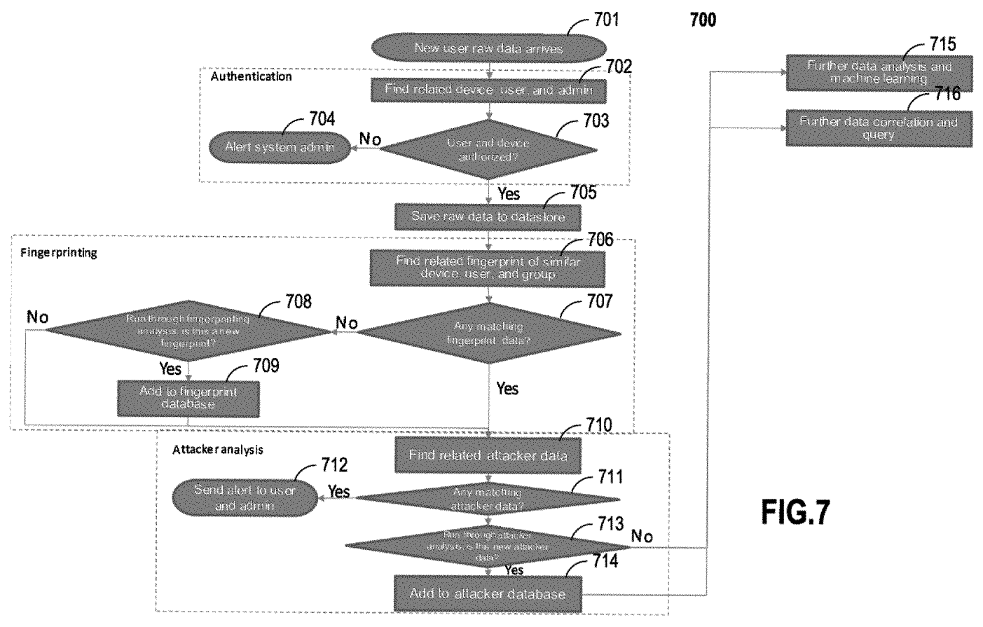

Referring to FIG. 7, a flowchart illustrating an example method 700 for operating a threat intelligence platform, according to one embodiment of the disclosure, is shown. At 701, new user raw data arrives. Operations 702 through 704 relate to authentication. At 702, the related device, user, and administrator are found. At 703, whether the user and device have been authorized is determined. If no at 703, at 704, the system administrator is alerted. If yes at 703, at 705, the raw data is saved to the data store. Operations 706 through 709 relate to fingerprinting. Then, at 706, related fingerprints of similar devices, users, and/or groups are searched for. At 707, whether there is any matching fingerprint data is determined. If no at 707, at 708, fingerprinting analysis is performed to determine whether the data relate to a new fingerprint. If yes at 708, at 709, the new fingerprint is added to the database. Operations 710 through 714 relate to attacker analysis. If yes at 707, or no at 708, or from 709, at 710, related attacker data is searched for. At 711, whether there is any matching attacker data is determined. If yes at 711, at 712, an alert is sent to the user and the administrator. Irrespective of the outcome at 711, at 713, attacker analysis is performed to determine whether the data is new attacker data. If yes at 713, at 714, the new attacker data is added to the attacker database. If no at 713, at 715 and 716, further data analysis and machine learning may be performed, and further data correlation and query may also be performed.

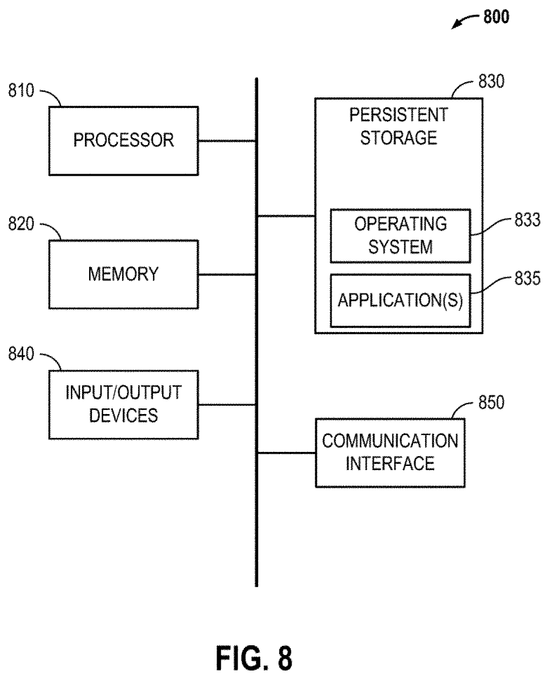

Referring to FIG. 8, a block diagram illustrating an example computing device 800 according to embodiments of the disclosure is shown. The device 800 may correspond to the cloud component of the CIP, or to sub-components within the cloud component, such as the security servers and the various modules of the cloud component. The device may comprise a processor 810, a memory 820, a persistent storage 830, one or more input/output devices 840, and a communication interface 850. The memory 820 may comprise a random access memory (RAM) and a read-only memory (ROM). An operating system 833 and one or more applications 835 may be stored in the persistent storage 830. The code stored in the persistent storage 830 may be loaded into the memory 820 and executed by the processor 810. When code is executed by the processor 810, the device 800 may perform one or more functions based on the code, such as the operating system 833 or the applications 835. The one or more applications 835 may be adapted for various functions and purposes. The communication interface 850 may enable the device 800 to communicate with one or more other devices using one or more known wired or wireless communication protocols.

Merely by way of example, one or more procedures described with respect to the method(s) discussed below may be implemented as code and/or instructions executable by a device (and/or a processor within a device). A set of these instructions and/or code may be stored on a non-transitory computer-readable storage medium, such as the persistent storage device(s) 830 described above. In some cases, the storage medium might be incorporated within a computer system, such as the device 800. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by the device 800 and/or might take the form of source and/or installable code, which, upon compilation and/or installation on the device 800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other computing devices such as network input/output devices may be employed.

It should be appreciated that aspects of the previously described processes may be implemented in conjunction with the execution of instructions by a processor (e.g., processor 810) of a device (e.g., device 800), as previously described. Particularly, circuitry of the devices, including but not limited to processors, may operate under the control of a program, routine, or the execution of instructions to execute methods or processes in accordance with embodiments described (e.g., the processes and functions of FIGS. 3 to 7). For example, such a program may be implemented in firmware or software (e.g. stored in memory and/or other locations) and may be implemented by processors and/or other circuitry of the devices. Further, it should be appreciated that the terms device, processor, microprocessor, circuitry, controller, SoC, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, LTE Advanced, 4G, 5G, CDMA, TDMA, OFDM, OFDMA, WiMAX, Wi-Fi, Bluetooth, Zigbee, LoRA, and Narrowband-IoT (NB-IoT). Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a virtual reality or augmented reality device, a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method implemented at a cybersecurity intelligence platform for responding to a cyber-attack, the method comprising:
detecting an attack at a client device;
receiving raw data from the attacked client device, the raw data comprising device data and attack-related data;
performing fingerprinting analysis and attacker analysis based on the raw data to generate fingerprinting data and attacker data;
issuing an incidence response to the attacked client device; and
issuing a federated response to a plurality of client devices belonging to a class based on the fingerprinting data and the attacker data.

2. The method of claim 1, wherein the client device and a cloud component of the cybersecurity intelligence platform communicate with each other through a bi-directional secure connection.

3. The method of claim 2, wherein the bi-directional secure connection is established as needed.

4. The method of claim 2, wherein the raw data from the attacked client device is transmitted to the cloud component of the cybersecurity intelligence platform through the bi-directional secure connection.

5. The method of claim 2, wherein the federated response is issued to the plurality of client devices from the cloud component of the cybersecurity intelligence platform through a plurality of bi-directional secure connections.

6. The method of claim 1, wherein the cybersecurity intelligence platform coordinates responses to cyber-attacks against a plurality of client devices of heterogeneous types.

7. The method of claim 1, wherein the class to which the plurality of client devices that are issued the federated response belong relates to one of: a business type, a device type, or a vertical industry.

8. The method of claim 1, wherein the fingerprinting analysis is performed when there is no active attack.

9. The method of claim 1, wherein the cybersecurity intelligence platform comprises a plurality of distributed cloud components.

10. The method of claim 1, wherein the cybersecurity intelligence serves as a secure proxy for one or more cloud-based services.

11. A non-transitory computer-readable medium comprising code which, when executed by a processor, causes the processor to perform operations implemented at a cybersecurity intelligence platform for responding to a cyber-attack, the operations comprising:
detecting an attack at a client device;
receiving raw data from the attacked client device, the raw data comprising device data and attack-related data;
performing fingerprinting analysis and attacker analysis based on the raw data to generate fingerprinting data and attacker data;
issuing an incidence response to the attacked client device; and
issuing a federated response to a plurality of client devices belonging to a class based on the fingerprinting data and the attacker data.

12. The non-transitory computer-readable medium of claim 11, wherein the client device and a cloud component of the cybersecurity intelligence platform communicate with each other through a bi-directional secure connection.

13. The non-transitory computer-readable medium of claim 12, wherein the bi-directional secure connection is established as needed.

14. The non-transitory computer-readable medium of claim 12, wherein the raw data from the attacked client device is transmitted to the cloud component of the cybersecurity intelligence platform through the bi-directional secure connection.

15. The non-transitory computer-readable medium of claim 12, wherein the federated response is issued to the plurality of client devices from the cloud component of the cybersecurity intelligence platform through a plurality of bi-directional secure connections.

16. The non-transitory computer-readable medium of claim 11, wherein the cybersecurity intelligence platform coordinates responses to cyber-attacks against a plurality of client devices of heterogeneous types.

17. The non-transitory computer-readable medium of claim 11, wherein the class to which the plurality of client devices that are issued the federated response belong relates to one of: a business type, a device type, or a vertical industry.

18. The non-transitory computer-readable medium of claim 11, wherein the fingerprinting analysis is performed when there is no active attack.

19. The non-transitory computer-readable medium of claim 11, wherein the cybersecurity intelligence platform comprises a plurality of distributed cloud components.

20. The non-transitory computer-readable medium of claim 11, wherein the cybersecurity intelligence serves as a secure proxy for one or more cloud-based services.
